(19) United States
(12) Patent Application Publication
(10) Pub. No.: US 2012/0100403 A1
(43) Pub. Date: Apr. 26, 2012

(54) ELECTROLYTIC CELL AND METHOD OF ESTIMATING A STATE OF CHARGE THEREOF

(75) Inventors: John S. Wang, Los Angeles, CA (US); Mark W. Verbrugge, Troy, MI (US); Elena Sherman, Culver City, CA (US); Ping Liu, Irvine, CA (US)

(73) Assignee: GM GLOBAL TECHNOLOGY OPERATIONS, INC., DETROIT, MI (US)

(21) Appl. No.: 12/912,439

(22) Filed: Oct. 26, 2010

(51) Int. Cl. H01M 10/42; H01M 4/62; H01M 4/48

(52) U.S. Cl. 429/50; 429/231.1; 429/232

(57) ABSTRACT

A lithium ion battery includes a positive electrode, a negative electrode, and an electrolyte operatively disposed between the positive and negative electrodes. The negative electrode contains a composite material including graphitic carbon and a disordered carbon.

### TECHNICAL FIELD

The present disclosure relates generally to lithium ion batteries.

### BACKGROUND

Lithium ion batteries are rechargeable batteries where lithium cations move from a positive electrode to a negative electrode during charging of the battery, and in the opposite direction when discharging the battery. The lithium ion battery also includes an electrolyte that carries the lithium ions between the positive electrode and the negative electrode when the battery passes an electric current therethrough.

### SUMMARY

A lithium ion battery includes a positive electrode, a negative electrode, and an electrolyte operatively disposed between the positive and negative electrodes. The negative electrode contains a composite material including graphitic carbon and a disordered carbon.

### BRIEF DESCRIPTION OF THE DRAWINGS

Features and advantages of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 schematically depicts a lithium ion battery according to an example disclosed herein;

FIG. 2 is a graph including profiles representing the relationship between an open circuit electric potential and a state of discharge of a lithium ion battery containing a negative electrode formed from a composite material and of another lithium ion battery containing an negative electrode formed from graphite alone;

FIGS. 3A through 3C are scanning electron micrograph (SEM) images for a mesocarbon microbead negative electrode (FIG. 3A), SUPERIOR™ graphite negative electrode (FIG. 3B), and a SUPERIOR™ graphite carbon/mesocarbon microbead mixed carbon negative electrode (FIG. 3C);

FIG. 4 is a graph showing a C/20 galvanostatic charge/discharge voltage response for the SUPERIOR™ graphite (SG), mesocarbon microbeads (MCMB), and SG/MCMB composite electrodes;

FIG. 5 is a graph showing the cyclic voltammetric (CV) responses for the SG and MCMB electrodes;

FIG. 6 is a graph showing a comparison of charge capacity at C/4, C/2, and 2C rates for MCMB, SG, and SG/MCMB electrodes;

FIG. 7 is a graph showing a comparison of cycling performance of SG, MCMB, and SG/MCMB electrodes at a C/4 rate;

FIG. 8 is a graph showing galvanostatic charge/discharge profiles obtained at C/20 rate for the LiFePO₄ positive electrode versus an SG/MCMB (80/20 wt %) negative electrode, and the LiFePO₄ positive electrode versus an SG negative electrode;

FIG. 9A is a graph showing simulation results of batteries including a LiFePO₄ positive electrode and a SG/MCMB composite negative electrode with various SG and MCMB mass ratios;

FIG. 9B is a graph showing the dV/dQ differential curves representing the simulation results of the batteries used to produce the results in FIG. 9A;

FIG. 10 is a graph showing an example of using both an OCV-SOD relationship and a dV/dQ differential curve as SOD markers to determine how much capacity or energy remains in a battery; and

FIG. 11 is a graph showing the specific capacity of a composite negative electrode (mAh/g) and the specific energy of a packaged battery (Wh/kg) as a function of a mass fraction of MCMB disordered carbon.

### DETAILED DESCRIPTION

The state of discharge (SOD) of a lithium ion battery may be determined by estimating or measuring an open circuit electric potential (also referred to herein as an open circuit voltage (OCV)) of the battery, and utilizing the estimated or measured electric potential in an algorithm to determine the SOD of the battery. The SOD estimation based on the open circuit electric potential of the battery may, in some cases, be challenging when the battery's electric potential remains substantially unchanged over a broad SOD range (e.g., from 0.1 to 0.9). In these cases, a small error in the cell potential estimation or measurement may result in a large error in the SOD estimation.

It is to be understood that when the lithium ion battery is in a discharging state, the positive electrode is a cathode and the negative electrode is an anode, and when the lithium ion battery is in a charging state, the positive electrode is an anode and the negative electrode is a cathode. An anode is an electrode through which electric current flows into a polarized electrical device. As such, current flows into the negative electrode during discharge and current flows into the positive electrode during charging.

It has been found that lithium ion batteries including a graphite negative electrode is a promising candidate for high power applications such as for use in hybrid electric vehicles (HEV) and various consumer applications, at least because of its high thermal stability and long life cycle. These batteries may also be useful in plug-in HEVs, extended-range electric vehicles (EREV), and battery-electric-vehicle (BEV) applications. During battery discharge, lithium ions are removed from the graphite at an electric potential that changes abruptly as the battery comes close to being completely discharged. However, this provides a relatively short window of time, in terms of the SOD estimation, for notification of the battery state before the battery reaches the end of discharge (i.e., when the battery is completely discharged). This phenomenon is shown in FIG. 2, whereby a profile representing an open circuit electric potential/SOD of the battery including the graphite (shown in dotted lines in FIG. 2) negative electrode shows that at a SOD of about 0.9, the voltage of the battery abruptly and rapidly drops off.

The inventors of the instant disclosure have found that a lithium ion battery including a negative electrode formed from a composite material including a graphitic carbon and a disordered carbon advantageously produces a more gradual change in the voltage of the battery as compared with graphite alone (as shown by the solid profile line in FIG. 2). The composite material for the negative electrode also retains at least some, if not all of the performance characteristics of the battery, as shown below at least with respect to the Examples. As shown in FIG. 2, the voltage of the battery including the graphite negative electrode (the dotted profile line) and the battery including the composite material (the solid profile line) overlap at a SOD range from about 0.2 to about 0.8. The disordered carbon in the composite material i) has a larger variation in electric potential than graphite alone, and ii) a lower specific capacity than graphite. However, the disordered carbon exhibits excellent cycling stability; and the open circuit voltage (OCV) of the disordered carbon is sensitive to its SOD. In contrast, the open circuit voltage of graphite alone is very insensitive to its SOD. As such, the composite material including graphite and a disordered carbon enables one to manipulate the shape of the profile representing the open circuit electric potential/SOD without a large compromise in storage capacity.

Further, the sensitivity of the disordered carbon in the composite material to the SOD positively affects the open circuit potential/SOD relationship in terms of improving an estimation of a then-current SOD of the battery. In many cases, the improved estimation of the then-current SOD enables earlier notification or warning of a complete discharge of the battery.

In an example, (still referring to FIG. 2) the profile representing the electric potential/SOD relationship of the battery including the composite material (i.e., the solid profile line), at a SOD from about 0.85 to about 0.95, has a slope whose magnitude is less than that of the profile for the battery having the negative electrode including graphite alone. The slope of the solid profile line at a SOD from about 0.85 to about 0.95 provides an observable state of discharge estimation based on the voltage of the battery. This is in contrast to the slope of the dotted profile line at a SOD from about 0.85 to about 0.95, where the state of discharge is less observable. In other words, the state of discharge of the battery including the composite material negative electrode (represented by the solid profile line in FIG. 2) may be estimated at a SOD of at least 0.15 prior to complete discharge of the battery, whereby the SOD of the battery including the graphite negative electrode may be estimated at a SOD of about 0.9 prior to complete discharge of the battery.

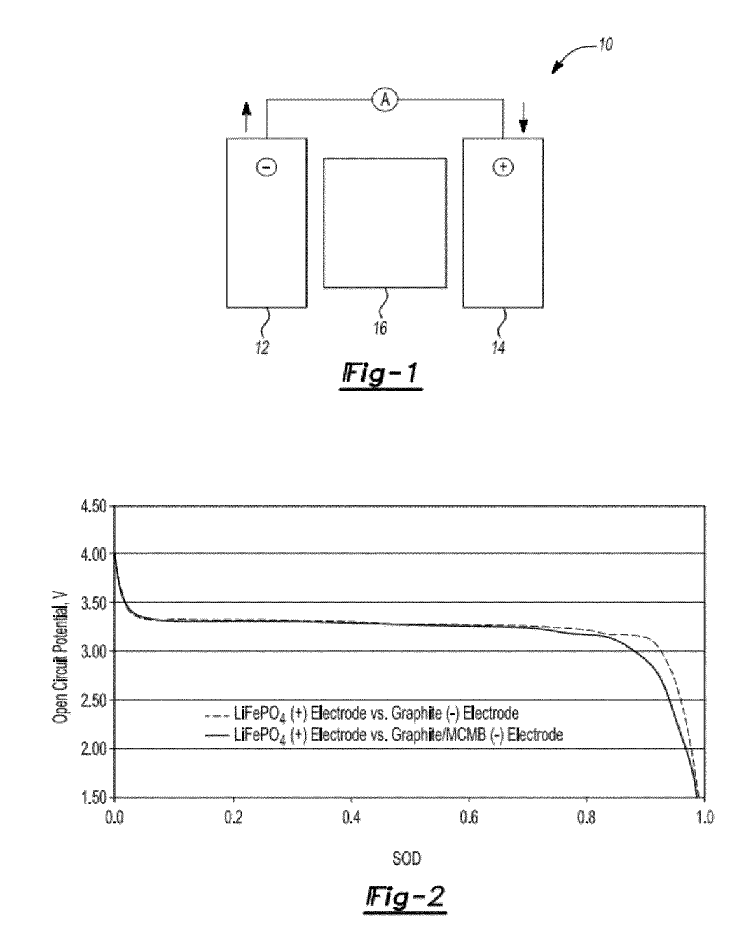

Referring now to FIG. 1, an example of a lithium ion battery 10 is shown. The lithium ion battery 10 is generally a rechargeable electrolytic cell including a negative electrode 12, a positive electrode 14, and an electrolyte 16 operatively disposed between the negative electrode 12 and the positive electrode 14. The arrows indicate that current is flowing out of the negative electrode and current is flowing into the positive electrode. Thus, the lithium ion battery 10 shown in FIG. 1 is shown in a charging state. It is to be understood that the lithium ion battery 10 also has a discharging state (not shown in FIG. 1) with current in the opposite direction. The lithium ion battery 10 may be used, for example, in a vehicle such as an HEV, a battery electric vehicle (BEV), a plug-in HEV, or an extended-range electric vehicle (EREV). The battery 10 may be used alone in, for example, in a battery system disposed in the vehicle, or may be one of a plurality of batteries of a battery module or pack disposed in the vehicle. In the later instance, the plurality of batteries may be connected in series or in parallel via electrical leads (not shown in FIG. 2). In some cases, the negative electrode 12, positive electrode 14, and electrolyte 16 may be disposed inside a container, which may be formed from a stiff or flexible polymer material, and may include a laminate including an inner laminated metal foil.

The negative electrode 12 of the lithium ion battery 10 is a composite material including a graphitic carbon and a disordered carbon. In an example, the graphitic carbon may be chosen from natural graphite, synthetic graphite, and combinations thereof. In another example, the disordered carbon is chosen from any carbon-based material that is disordered and exhibits a cell potential/SOD profile over regions of the OCV-SOD profile where the potential is sensitive to the state of discharge. As such, the disordered carbon for the negative electrode 12 exhibits a charging and discharging behavior that differs significantly from graphite. Some non-limiting examples of disordered carbons include mesocarbon microbeads; cokes, soft carbons and hard carbons (such as, e.g., petroleum coke, coal coke, celluloses, saccharides, and mesophase pitches), artificial graphites (such as, e.g., pyrolytic graphite), carbon blacks (such as e.g., acetylene black, furnace black, Ketjen black, channel black, lamp black, and thermal black); asphalt pitches; coal tar; activated carbons (including active carbons having different structural forms); polyacetylenes; and combinations thereof. The disordered carbon may also be chosen from a carbon that can accommodate guest lithium ions and can give a relatively smooth variation in its open-circuit potential profile compared with a lithium reference electrode. As used herein, an open-circuit potential having a smooth variation in its profile refers to one that has no abrupt voltage changes, and the slope of the profile does not equal zero or infinity. In a non-limiting example, the amount of the composite material (i.e. graphitic carbon and disordered carbon) present in the negative electrode ranges from about 90 wt % to about 98 wt %. In another non-limiting example, the amount of the composite material ranges from about 92 wt % to about 96 wt %.

In an example, the negative electrode 12 further includes at least one other material such as, e.g., a binder. Some non-limiting examples of the binder include polyvinylidene fluoride (PVDF) and styrene-butadiene rubber (SBR). In a non-limiting example, the amount of the other material(s) present in the negative electrode 12 ranges from about 2 wt % to about 10 wt %. In another non-limiting example, the amount of the other material(s) present in the negative electrode 12 ranges from about 3 wt % to about 5 wt %.

The positive electrode 14 of the lithium ion battery 10 may, for example, be chosen from any positive electrode material that can reversibly accommodate lithium or lithium ions. Desirable positive electrode materials are chosen from those that exhibit a relatively flat electric potential/SOD profile. As used herein, a “flat electric potential/SOD profile” (or some other variation of the term) refers to the portion(s) of the electric potential/SOD profile where the electric potential of the positive electrode material is insensitive to the state of discharge under a relatively constant charge or discharge of the battery 10. In other words, the electric potential (or the open circuit voltage (OCV)) of the active material (in this case, the disordered carbon) changes minimally over a very broad range of discharge. In a non-limiting example, the electric potential/SOD profile is considered to be flat when the slope of the profile is substantially zero. As used herein, a slope that is “substantially zero” refers to a slope that is exactly zero, or to a slope that is close to zero, e.g., within +/−0.1V. In an example with more precision of measurement in a control unit, “substantially zero” may refer to a slope of the electric potential/SOD profile that is between −0.005V and 0.005V. Some non-limiting examples of suitable positive electrode materials include LiMO₂, where M is chosen from a transition metal such as, e.g., Co, Ni, Mn, and combinations thereof. LiM₂O₄, where M is chosen from a transition metal such as, e.g., Mn, Ti, Ni, and combinations thereof and/or LiMPO₄, where M is chosen from a transition metal such as, e.g., Fe, Mn, Co, and combinations thereof.

It is to be understood that any known electrolyte is contemplated as being within the purview of the present disclosure. In an example, the electrolyte 16 may be chosen from a liquid electrolyte or a gel electrolyte. In a further example, the electrolyte 16 is a salt dissolved in an organic solvent or a mixture of organic solvents. Some non-limiting examples of salts include LiPF₆, LiBF₄, LiClO₄, LiAsF₆, lithium bis(fluorosulfonyl)imide salt, and/or the like. Some non-limiting examples of solvents include ethylene carbonate, dimethyl carbonate, methylethyl carbonate, propylene carbonate, and/or the like, and/or combinations thereof.

Also disclosed herein is a method of estimating the state of discharge of an electrolytic cell, such as a lithium ion battery. In an example, the SOD of the battery 10 may be estimated by generating the profile of the open circuit electric potential (measured in volts) versus the SOD (in terms of percentage) for the battery, and then estimating the SOD from the profile. The profile may include, for example, a look up table containing values for the open circuit potential corresponding to discharge states. These open circuit potential values may be generated, for instance, by slowly discharging the battery 10 (e.g., at a C/20 rate or below), and measuring the voltage of the battery 10 at predetermined states of discharge via charge counting.

To further illustrate the present disclosure, examples are given herein. It is to be understood that these examples are provided for illustrative purposes and are not to be construed as limiting the scope of the present disclosure.

### EXAMPLES

### Example 1

Three different negative electrodes were cast using a doctor-blade technique: i) graphite (SG, SUPERIOR™ Graphite, SLC 1520, Superior Graphite Co., Chicago, Ill.), mesocarbon microbeads (MCMB) disordered carbon (MCMB 10-10), and a graphite/MCMB disordered carbon mixed composite (SG/MCMB). The compositions of the SG and MCMB electrodes were 93 wt % active carbon material, 3 wt % carbon black (SUPER P®, TIMCAL, Ltd., Switzerland), and 4 wt % SBR binder (an aqueous styrene-butadiene rubber binder, LHB-108P, LICO Technology Corp., Taiwan). For the SG/MCMB composite negative electrode, the composition was 74.4 wt % SG, 18.6 wt % MCMB, 3 wt % carbon black and 4 wt % SBR binder. The mass ratio between SG and MCMB was thus 4:1.

For the full-cell experimental studies, LiFePO₄ was used as the positive electrode, which was prepared using commercially available 2.2 Ah, 26650 cylindrical cells (available from A123Systems, MA). After disassembling the 26650 cylindrical cells in an Argon-filled glove box, circular disks were punched out of the positive electrode tape and rinsed with dimethyl carbonate (DMC).

All of the electrochemical experiments were carried out in Swagelok cells inside the Argon filled glovebox. For half-cell testing, lithium metal was used as the counter electrode. The electrolyte solution was 1 M LiPF₆ in 1:1 v/v ethylene carbonate (EC) and dimethyl carbonate (DMC). A CELGARD® 3501 (25 μm thick microporous polypropylene film with 40% porosity) was used as the separator. Galvanostatic studies were performed with an ARBIN® BT-2000 battery testing station. The cycling voltage ranged from 10 mV to 2 V for the carbon and 2.5 to 4 V for the LiFePO₄ electrode (relative to a Li/Li+ electrode). The cyclic voltammetry (CV) experiments were carried out using a PAR EG&G 283 potentiostat. The cutoff voltages for the carbon-FePO₄ cell were 2.0 and 3.6 V.

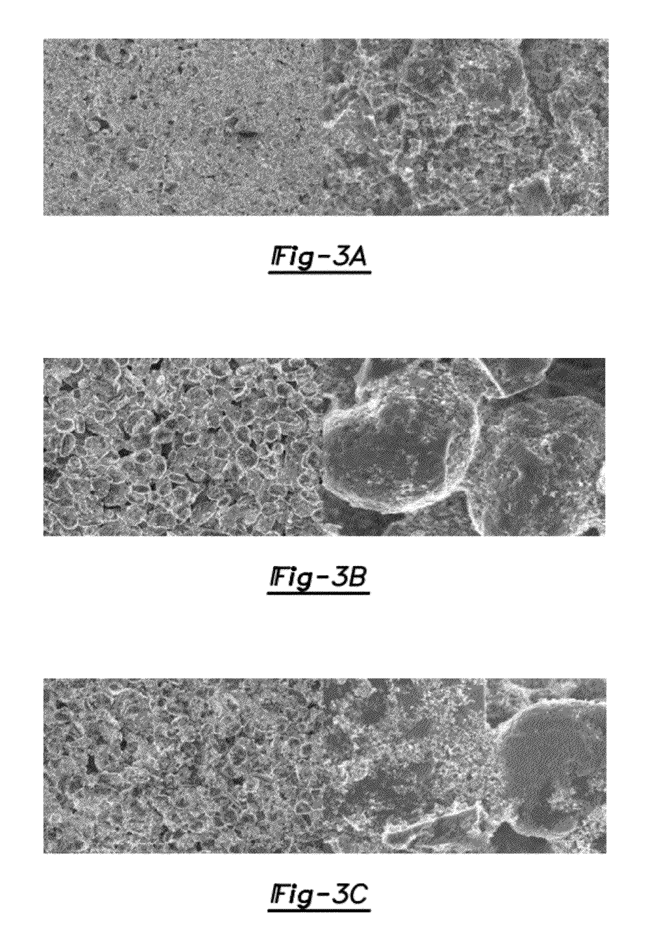

FIGS. 3A-3C show scanning electron micrograph (SEM) images for three different negative electrodes: MCMB disordered carbon (FIG. 3A); SG (FIG. 3B); and SG/MCMB mixed carbon (FIG. 3C). As shown in these images, the carbon particles of MCMB electrode are more densely packed than those of the SG electrode, and the composite electrode appears to be smoother and less porous than the SG electrode. The MCMB disordered carbon particles also appear to be complementary to the larger, spherical shaped SG particles in forming a densely packed electrode. This architecture of the composite electrode may promote better electrical contact between particles.

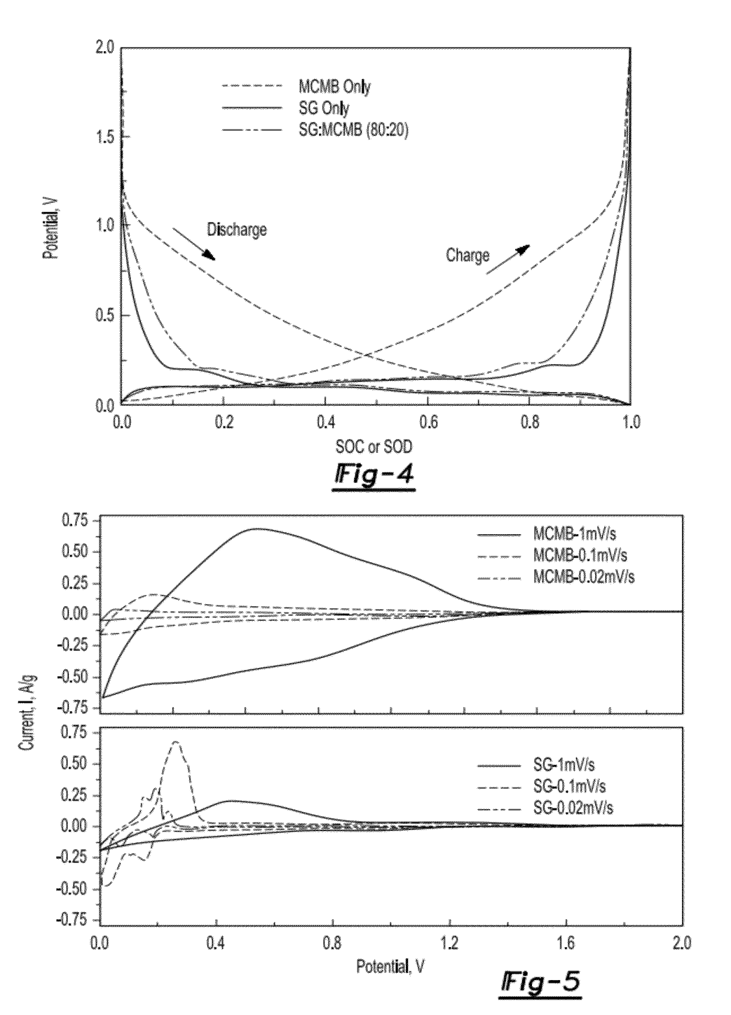

FIG. 4 shows the C/20 galvanostatic charge/discharge voltage responses of the SG, MCMB, and SG/MCMB composite electrodes. The potential of MCMB gradually decreases with SOD without any plateaus on the charge/discharge profile. In contrast, the SG delivers most of its capacity between 0 and 0.2 V, and the electrode potential is less sensitive to SOD. The potential-SOD characteristics of the MCMB electrode material are favorable for SOD estimations since electrode potential is a reliable indicator of SOD. The mixed SG/MCMB electrode inherits the features from both SG and MCMB materials. The electrode potential changes continuously with SOD until reaching about 0.2 V with about 17% of electrode capacity delivered.

The rate capability of MCMB disordered carbon is better than that of SG, as shown in FIG. 5, where cyclic voltammetric (CV) responses of both electrodes are recorded at sweep rates of 1 mV/s, 0.1 mV/s, and 0.02 mV/s. The MCMB electrode reveals a featureless voltammetric response over a broad potential range. The response arises from the numerous lithium intercalation sites with a wide variation in energies, characteristic of single-phase electrodes. These results are consistent with the potential profiles during galvanostatic cycling shown in the top portion of FIG. 5. In contrast, the SG electrode shows well-defined redox (reduction-oxidation) peaks at slow sweep rates, e.g. 0.02 mV/s. The peaks represent the co-existence of lithiated graphite compounds of different stages. Each peak corresponds to a plateau region on the (low rate) galvanostatic potential profile. However, the peaks were not visible at 1 mV/s, indicating poor reaction kinetics due to slow diffusion of lithium ions. Such kinetics effects can also be seen by comparing the charge storage performance at different sweep rates. In CV responses, the area underneath the curves has units of power per unit mass as plotted and reflects the total stored charge. As the sweep rate decreases, the total amount of stored charge increases. At a sweep rate of 1 mV/s, the total stored lithium capacity (anodic process) for MCMB disordered carbon was calculated to be 135 mAh/g (55% of its full capacity) while the SG electrode only stored 27 mAh/g (7% of its full capacity). These results are consistent with the MCMB disordered carbon material exhibiting faster lithium intercalation/deintercalation kinetics than the SG material.

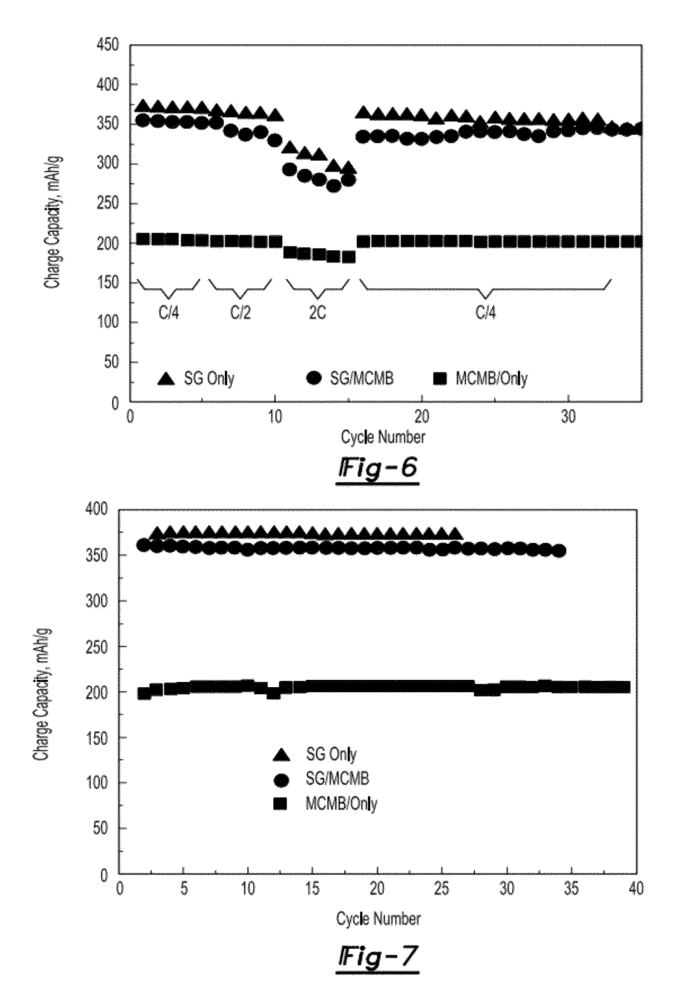

FIG. 6 shows a comparison of charge capacity at C/4, C/2, and 2C rates for MCMB disordered carbon, SG, and the SG/MCMB composite electrode. At the 2C rate, the charge capacity of MCMB fades very slightly with cycling while that of SG fades significantly. The superior high charge rate capabilities of MCMB disordered carbon are likely related to its structure. Disordered carbon materials such as MCMB have a large d₀₀₂ spacing, typically about 0.37 nm. Consequently, MCMB can accommodate lithium between the layers with minimal structural deformation. Graphite, in comparison, has a smaller d₀₀₂ spacing (0.34 nm). The spacing increases up to 10% during lithium intercalation. Such structural change can potentially hinder both the rate capability and cycling stability. Therefore, adding MCMB disordered carbon to SG also improves its charge rate capability, as shown in FIG. 6.

FIG. 7 shows a comparison of cycling performance of SG, MCMB disordered carbon, and the SG/MCMB composite electrodes at C/4 rate. The cycling performance of all three material compositions is excellent. However, the specific charge capacity of MCMB disordered carbon electrode is only at 205 mAh/g as compared to a specific charge capacity of 370 mAh/g for SG. For the 80:20 wt % ratio SG:MCMB mixed electrode, the specific charge capacity was above 350 mAh/g. The charge capacity of the mixed composite electrode is slightly higher than a summation of the expected capacities from the two components at C/4 rate.

Accordingly, as shown in FIGS. 4, 5, and 6, the performance of the composite electrode, in terms of capacity (mAh/g) and rate (in terms of C rate) is similar or in fact better than that of either one of the carbons (i.e., the graphite or the disordered carbon) individually.

### Example 2

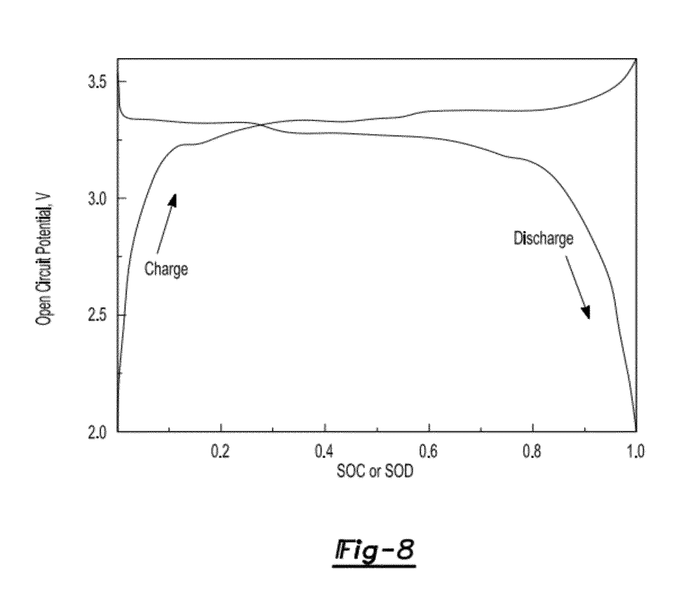

A cell composed of LiFePO₄ positive and SG/MCMB mixed composite negative was constructed to validate the model simulation used to illustrate the concept of using the SG/MCMB mixture to improve SOD estimation shown in FIG. 2. Galvanostatic charge/discharge profiles obtained at C/20 rate are shown in FIG. 8. The profiles are in excellent agreement with the simulation results shown in FIG. 2, demonstrating that mixing MCMB disordered carbon in the negative electrode can create a clear SOD marker before the end of discharge for the battery.

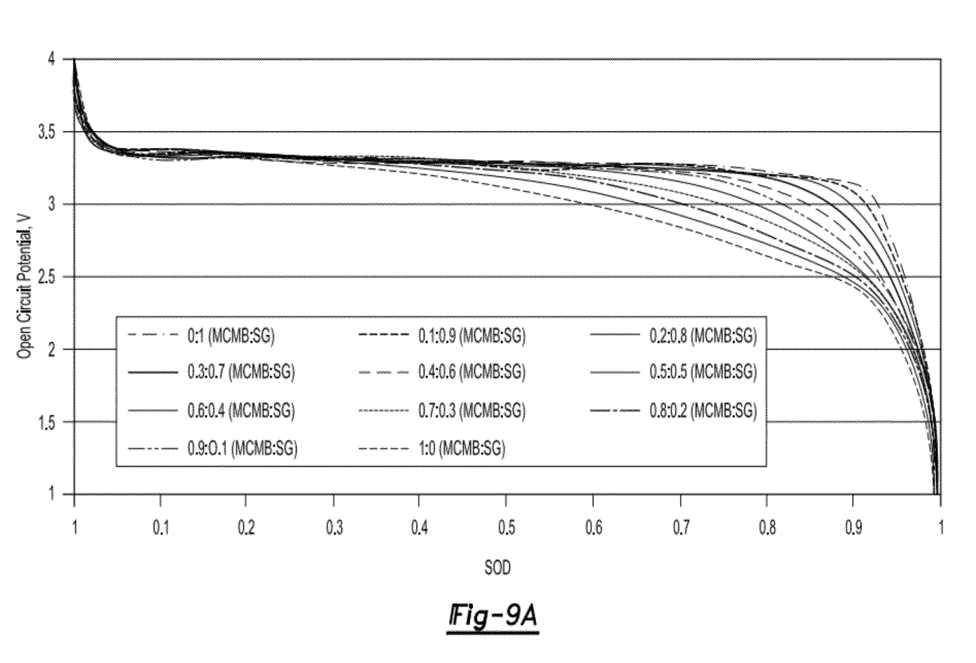

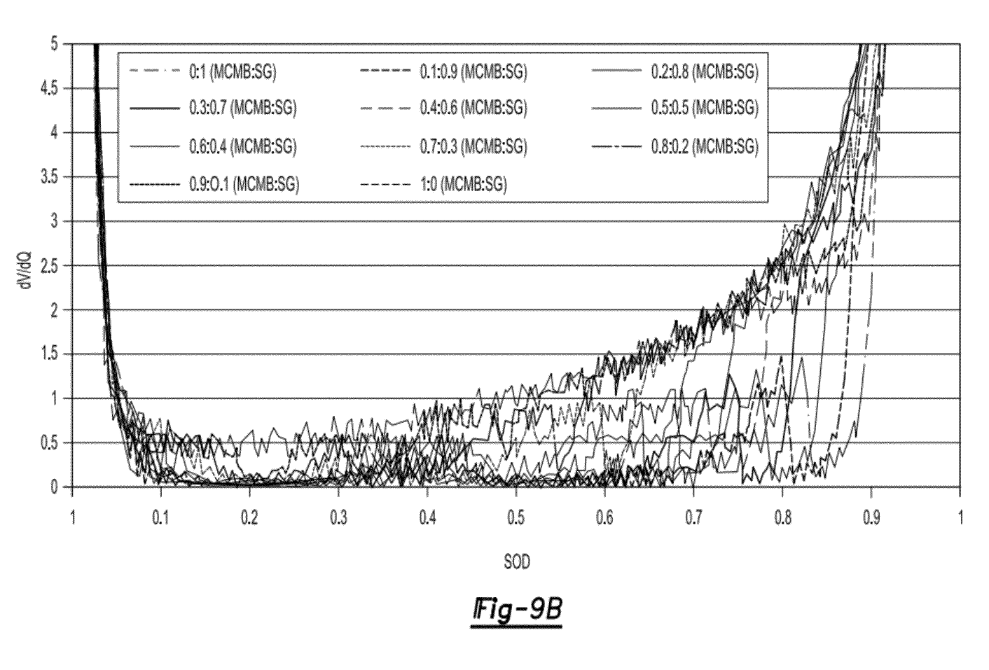

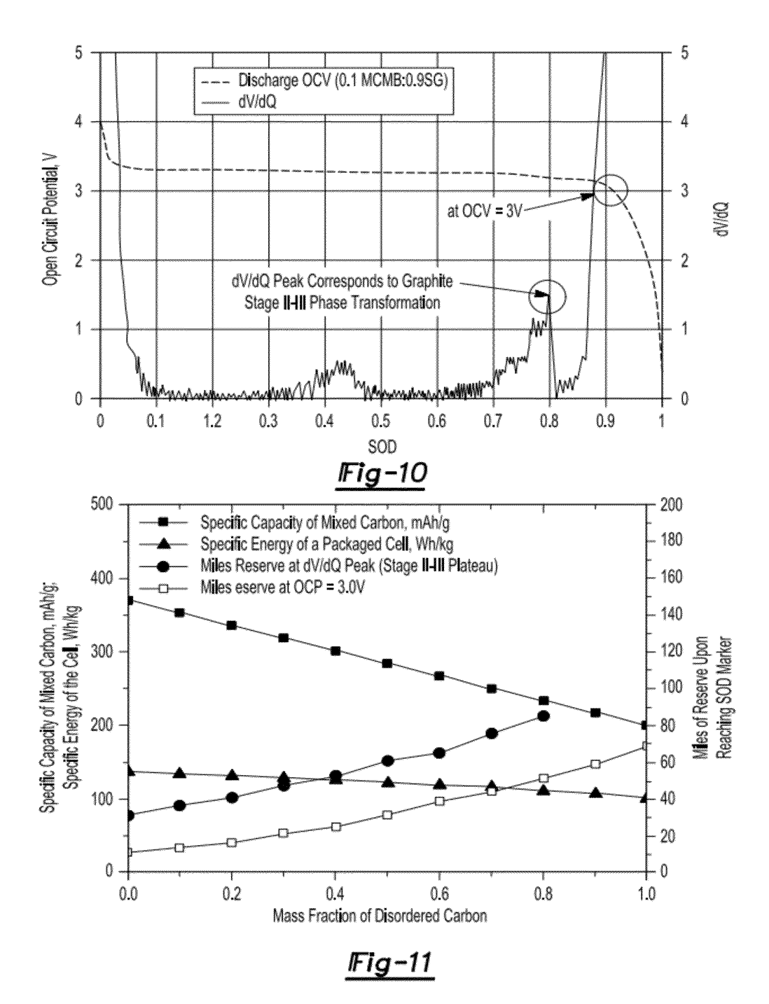

While mixing MCMB disordered carbon can enhance the accuracy of voltage based SOC estimations by creating clear SOC markers, it is important to determine how the SOC marker changes with MCMB to SG ratios for application purposes. When the battery is used to power an electric vehicle, the remaining SOC or capacity can be used to estimate the mileage the vehicle can provide before reaching end of discharge. FIG. 9A shows simulation results of cells comprising a LiFePO₄ positive and a SG/MCMB composite negative with various SG and MCMB mass ratios. As the mass fraction of MCMB disordered carbon increases, the sloping voltage region toward the end of discharge encompasses a wider range of SOC. Another method to quantitatively identify this mass-ratio dependent SOC-OCV relationship is by constructing dV/dQ differential curves (FIG. 9B). As the mass fraction of MCMB disorder carbon decreases, a dV/dQ peak toward the end of discharge becomes visible. The dV/dQ peak represents the lithium deintercalation (extraction) from graphite during the stage II-III phase transformation. Its peak shift is consistent with the increase of the mass ratio of graphite. FIG. 10 illustrates an example of using both the OCV-SOD relationship and the dV/dQ differential curve as the SOC markers to determine how much capacity or energy remains in a battery. In the sloping voltage region near the end of discharge, such as when OCV=3.0 V, OCV-SOD relationship can be very effective to identify the SOC. In addition, the dV/dQ peak of the graphite stage II-III phase transformation can also be a clear SOC indicator as shown in FIG. 10.

Further, the voltage marker was implemented on the OCV-SOD relation (at OCV=3.0 V), and a dV/dQ peak from the differential curve to determine the miles of reserve upon reaching these markers for a battery-powered electric vehicle. The calculations were based on a 40 kWh battery pack and a vehicle energy consumption of 200 Wh/mile. FIG. 11 shows a summary of the results for various mass fraction of MCMB disordered carbon. The specific capacity of the composite negative electrode (mAh/g) and the specific energy of a packaged cell (Wh/kg) are plotted as function of mass fraction of MCMB disordered carbon (the primary y-axis on the left). The specific energy densities at various mass fraction of MCMB disordered carbon were calculated based on a packaged cell in which the positive electrode capacity is 150 mAh/g and the cell packing efficiency is 40% (estimated based on a state of the art prismatic cell). To streamline the analysis and exposition, the positive electrode to negative electrode capacity ratio was kept at 1:1 (a 5 to 10% excess in the negative electrode capacity is common in practice). Because MCMB has a lower capacity than that of SG graphite, the specific capacity decreases as the mass fraction of MCMB increases. Thus, the amount of MCMB disordered carbon should be minimized in order to achieve higher energy densities. On the other hand, because the total mass of active carbon at the negative electrode contributes a small fraction of the weight of a packaged cell, the mass fraction of MCMB disordered carbon does not substantially impact the specific energy of the cell. The miles of reserve upon reaching the SOC markers are plotted on the secondary y-axis on the right. Consistent with the above discussion, the miles of reserve increase with increasing MCMB to SG ratios. These results further demonstrate that one can design a battery with a preselected mile reserve by tuning the ratio of disordered carbon to graphite.

It is further to be understood that the ranges provided herein include the stated range and any value or sub-range within the stated range. For example, a range from about 0.2 to about 0.8 should be interpreted to include not only the explicitly recited limits of about 0.2 to about 0.8, but also to include individual values, such as 0.3, 0.5, 0.65, etc., and sub-ranges, such as from about 0.3 to about 0.6, etc. Furthermore, when “about” is utilized to describe a value, this is meant to encompass minor variations (up to +/−10%) from the stated value.

While several embodiments have been described in detail, it will be apparent to those skilled in the art that the disclosed embodiments may be modified. Therefore, the foregoing description is to be considered non-limiting.

1. A lithium ion battery, comprising:
a positive electrode;
a negative electrode containing a composite material, the composite material including a graphitic carbon and a disordered carbon; and
an electrolyte operatively disposed between the positive and negative electrodes.

2. The lithium ion battery as defined in claim 1 wherein the positive electrode is chosen from i) LiMO₂, wherein M is chosen from a transition metal, ii) LiM₂O₄, wherein M is chosen from a transition metal, and iii) LiMPO₄, wherein M is chosen from a transition metal.

3. The lithium ion battery as defined in claim 1 wherein the disordered carbon is chosen from mesocarbon microbeads, petroleum coke, coal coke, celluloses, saccharides, mesophase pitches, artificial graphites, carbon blacks, asphalt pitches, coal tar, activated carbons, polyacetylenes, and combinations thereof.

4. The lithium ion battery as defined in claim 1 wherein the composite material has a profile defined by its open circuit voltage versus a state of charge such that, at a state of charge ranging from about 0.85 to about 0.95, a magnitude of a slope of the profile of the composite material is less than that of graphite alone.

5. The lithium ion battery as defined in claim 4 wherein the profile of the composite material at a state of discharge ranging from 0.85 to about 0.95 provides an observable state of charge estimation based on a voltage of the lithium ion battery.

6. The lithium ion battery as defined in claim 5 wherein a slope of the profile is substantially zero at a state of charge ranging from about 0.05 to about 0.80.

7. The lithium ion battery as defined in claim 1 wherein the amount of the graphite ranges from about 70 wt % to about 80 wt % in the composite material, and wherein the amount of the disordered carbon ranges from 10 wt % to about 30 wt % in the composite material.

8. An electrode for a lithium ion battery, comprising:
a composite material formed from a graphitic carbon and a disordered carbon, the composite material present in an amount ranging from about 90 wt % to about 95 wt % of the negative electrode; and
at least one other material present in an amount ranging from about 10 wt % to about 5 wt %.

9. The electrode as defined in claim 8 wherein the disordered carbon comprises mesocarbon microbeads.

10. The electrode as defined in claim 8 wherein the composite material has a profile defined by its open circuit electric potential versus a state of discharge of the electrolytic cell such that, at a state of discharge ranging from about 0.85 to about 0.95, a magnitude of a slope of the profile of the composite material is less than that of graphite alone.

11. The electrode as defined in claim 8 wherein the at least one other component comprises a binder.

12. A method of estimating a state of charge of an electrolytic cell, comprising:
forming the electrolytic cell, including:
a positive electrode;
a negative electrode including a composite material, the composite material including a graphitic carbon and a disordered carbon; and
an electrolyte operatively disposed between the positive and negative electrodes;
generating a profile of an open circuit electric potential versus a state of charge of the electrolytic cell, the profile including a region defined by when the state of charge ranges from about 0.85 to about 0.95, wherein the region has a magnitude of a slope that is less than that of an other profile for an other electrolytic cell including a negative electrode formed from the graphitic carbon alone; and
estimating the state of charge of the electrolytic cell from the profile.

13. The method as defined in claim 12 wherein the positive electrode is chosen from i) LiMO₂, wherein M is chosen from Co, Ni, Mn, and combinations thereof, ii) LiM₂O₄, wherein M is chosen from Mn, Ti, Ni, and combinations thereof, and iii) LiMPO₄, wherein M is chosen from Fe, Mn, Co, and combinations thereof.

14. The method as defined in claim 12 wherein the disordered carbon is chosen from mesocarbon microbeads, petroleum coke, coal coke, celluloses, saccharides, mesophase pitches, artificial graphites, carbon blacks, asphalt pitches, coal tar, activated carbons, polyacetylenes, and combinations thereof.

15. The method as defined in claim 12 wherein the electrolytic cell is a lithium ion battery.

16. The method as defined in claim 12 wherein the estimating is accomplished at a state of charge of at least 0.15 prior to a complete discharge of the electrolytic cell.
